(19) United States
(12) Patent Application Publication
(10) Pub. No.: US 2025/0289652 A1
(43) Pub. Date: Sep. 18, 2025

(54) RECEPTACLE ASSEMBLIES WITH USER ASSIST

(71) Applicant: simplehuman, LLC, Torrance, CA (US)

(72) Inventors: Frank Yang, Rancho Palos Verdes, CA (US); Joseph Sandor, Newport Beach, CA (US); Cory Bowman, Mission Viejo, CA (US); Di-Fong Chang, Torrance, CA (US)

(21) Appl. No.: 19/078,023

(22) Filed: Mar. 12, 2025

Related U.S. Application Data
(60) Provisional application No. 63/565,415, filed on Mar. 14, 2024.

(51) Int. Cl. B65F 1/16; B65F 1/00

(52) U.S. Cl. CPC B65F 1/163; B65F 1/006; B65F 1/1646; B65F 2250/11; B65F 2250/114

(57) ABSTRACT

Receptacle assemblies with user assists are disclosed. The receptacle assembly can include a container, a lid, a foot pedal, a linkage configured to transmit force from the foot pedal to the lid, and a user assist. The user assist can be configured to reduce the amount of force needed to be applied by the user to open the lid and/or to dampen movement of the pedal during closing of the lid.

### PRIORITY

This application claims the priority benefit of U.S. Provisional Patent Application No. 63/565,415, filed Mar. 14, 2024, the entirety of which is incorporated by reference herein.

### BACKGROUND

This application relates generally to receptacles for holding items, and specifically to receptacles with moving lids actuated by foot pedals.

Receptacles, such as trash cans, can include a moving lid that opens and closes. This lid can be moved by a user from the closed position to the open position by applying a downward force on a foot pedal. If the lid is especially large or heavy, the force required to be exerted by the user on the food pedal can be significant. Once the downward force on the foot pedal is removed, a heavy lid can move rapidly from the open position to the closed position under the influence of gravity. When the lid returns to the closed position, it can hit the top of the receptacle with significant force, creating a loud noise and imparting force and vibration into the receptacle that can lead to damage and wear over time.

### Summary of Certain Aspects

In some embodiments, a receptacle system with a lid and foot pedal is provided that balances and calibrates various forces within the system to provide easy opening and quiet closing of the lid using the foot pedal. The receptacle system can include one, two, or more large, separate holding compartments, as well as a large and heavy lid that covers both holding compartments. The lid can be made of a metal and/or can include one or more metal components that form a majority of the surface area of the lid that is visible from the outside when the lid is closed. The receptacle system can include a foot pedal, a user assist such as a compression spring, a motion damper, and an opening linkage rod. The user assist, the motion damper, and the lid can be selected to work together to create an arrangement that provides easy lid opening and quiet closing.

The user assist can be configured to store and deploy energy. For example, when the pedal is moved (e.g., depressed) from a resting position to an actuated position, energy can be transferred from the user assist to the pedal. Potential energy stored in the user assist (e.g., a spring in a non-relaxed state) can be converted to kinetic energy for moving the pedal. As another example, when the pedal is moved (e.g., raised) from the actuated position to the resting position, energy can be transferred from the pedal to the user assist and/or the user assist can inhibit, slow, and/or dampen movement of the pedal. Kinetic energy of the moving pedal can be converted to potential energy that is stored in the user assist, such as due to the user assist (e.g., a spring) being moved to a deflected state. In several embodiments, the user assist is in a more energized (and/or less relaxed) state when the pedal is in a resting position and/or the user assist is in a less energized (and/or more relaxed) state when the pedal is in an actuated position. The energy stored in and deployed by the user assist can aid in moving the pedal toward the actuated position (e.g., to open the lid) and/or dampening movement of the pedal toward the resting position (e.g., to quietly close the lid). In various embodiments, energy is transferred between the user assist and pedal as the pedal moves between the resting and actuated positions.

The size and energy state of the user assist can vary based on the position of the pedal. In certain implementations, the user assist has a shorter longitudinal length and greater energy state when the pedal is in the resting position and/or the user assist has a longer longitudinal length and lesser energy state when the pedal is in the actuated position. In some implementations, the user assist is in a compressed state when the pedal is in the resting position and/or is in an extended state when the pedal is in the actuated position. In some variants, the user assist is in an excited (e.g., more energized) state when the pedal is in the resting position and/or is in a relaxed (e.g., less energized) state when the pedal is in the actuated position.

In several implementations, a receptacle in accordance with the present disclosure includes one or more containers. The receptacle can include a first container configured to receive a first type of material (e.g., trash) and a second container configured to receive a second type of material (recyclables, compostables, etc.). The containers can be discrete and/or separate such that the types of materials are contained and/or do not mix. The receptacle can include a movable lid configured to selectively cover and uncover the one or more containers, such as the first container and the second container, at the same time. The lid has a weight. The weight can be relatively heavy, due to the size and/or material of the lid. For example, a portion (e.g., an exterior, top, front side, lateral sides, etc.) of the lid can be metal, such as aluminum or stainless steel. The receptacle can include a base supporting the one or more containers.

The receptacle can have an actuator, such as a foot pedal. The receptacle can include a linkage configured to transmit force between the actuator and the lid. The receptacle can have a damper configured to slow a transition of the lid from an uncovered (e.g., open) position to a covered (e.g., closed) position. The damper can be configured to provide a resistance force to the actuator.

The receptacle can have a user assist. The user assist can be positioned between a top wall of the base and an upper surface of the foot pedal. The user assist can be configured to apply a motivating force to the foot pedal.

In certain implementations, one or more of the weight of the lid, the resistance force of the damper, and the motivating force of the user assist are selected to permit the lid to transition from the covered to the uncovered position upon the application of a force by a user to the foot pedal. The force can be less than would be needed to open the lid without the user assist. The force can be, for example: between about 50 N and about 100 N, between about 60 N and about 85 N, between about 70 N and about 80 N, between about 71 N and about 75 N, or otherwise.

In some variants, the user assist is positioned adjacent a front wall of the receptacle. In some embodiments, the user assist is not connected with a rear wall and/or not positioned on an exterior surface of the receptacle. The damper can, in certain variants, be connected to the base. In some embodiments, the damper is positioned near or adjacent a rear wall of the receptacle. According to some implementations, the receptacle can be configured such that, during movement of the lid to the covered position, the user assist is compressed by the foot pedal. In some variants, the receptacle can be configured such that, during movement of the lid to the covered position, the user assist is stretched. The foot pedal can have a recess configured to receive the user assist.

In accordance with some implementations, a receptacle includes a container, a movable lid configured to selectively cover and uncover the container, a base supporting the container, an actuator (e.g., a foot pedal), and a linkage configured to transmit force between the foot pedal and the lid.

Some variants of the receptacle have a damper configured to slow the lid at least during some of the movement from an uncovered (e.g., open) position to a covered (e.g., closed) position. The damper can be configured to apply a resistive force to the foot pedal or linkage rod in response to movement of the lid from the covered position to the uncovered position. The damper can be in a rear portion of the receptacle, such as a central rear portion.

The receptacle can have a user assist, such as a spring. The user assist can be positioned between a top wall of the base and an upper surface of the foot pedal. The user assist can be configured to apply a motivating force to the foot pedal.

In certain implementations, at least one of a weight of the lid, a resistive force of the damper, and the motivating force of the user assist are selected such that the lid transitions from the covered position to the uncovered position upon the application of a force by a user. In some implementations, such user applied force is less than about 100 N, at least about 61 N and/or less than or equal to about 85 N, about 75 N±5 N, in the range of about 70 N to about 75 N, or less than the weight of the lid.

In several implementations, the user assist is configured to provide a force that aids in opening the lid. In some embodiments, the user assist is positioned adjacent a front wall of the receptacle. In some variants, the lid is made of metal or plastic.

In certain variants, the damper is configured to dampen movement of the lid during movement from the uncovered position to the covered position, such as the entire extent of movement or during only a portion of the movement. In some embodiments, the damper is configured to provide more resistance when the lid is moving from the uncovered position to the covered position than when the lid is moving from the covered position to the uncovered position. In certain embodiments, the damper is positioned near or adjacent a rear wall of the receptacle.

In some implementations, a method of manufacturing a receptacle assembly can include attaching a body unit with a lid unit and a base portion to form a closed chamber, connecting (e.g., pivotally) an actuator (e.g., a foot pedal) with the base portion. The method can include operably connecting a linkage rod with the actuator and the lid unit such that the lid is configured to move in response to movement of the actuator. The method can include positioning a damper near a rear wall of the receptacle and/or compressing a user assist between the foot pedal and the base portion. According to certain variants, the method includes positioning the user assist near a front wall of the body unit. In some implementations, the method includes receiving a first end of the user assist in a recess in the base portion.

For purposes of summarizing the disclosure, certain aspects, advantages and features of the inventions are described herein. Not necessarily any or all such advantages are achieved in accordance with any particular embodiment of the inventions disclosed herein. No aspects of this disclosure are essential or indispensable.

### BRIEF DESCRIPTION OF THE DRAWINGS

The abovementioned and other features of the embodiments disclosed herein are described below with reference to the drawings. The drawings show embodiments that are intended to illustrate, but not to limit, the scope of this disclosure. Various features of the different disclosed embodiments can be combined to form further embodiments, which are part of this disclosure.

FIG. 1 schematically illustrates an example of a receptacle assembly with a user assist and a lid.

FIG. 2 illustrates a front perspective view of another example of a receptacle assembly with a user assist and with the lid closed and a pedal in an actuated position.

FIG. 3 illustrates a front perspective view of the receptacle assembly of FIG. 2 with the lid open and the pedal in an actuated position.

FIG. 4 illustrates a rear perspective view of the receptacle assembly of FIG. 2 with the lid open.

FIG. 5 illustrates a top plan view of the receptacle assembly of FIG. 2 with the lid open.

FIG. 6 illustrates a top plan view of the receptacle assembly of FIG. 2.

FIG. 7 illustrates a bottom plan view of the receptacle assembly of FIG. 2.

FIG. 8 illustrates a perspective view of a base unit of the receptacle assembly of FIG. 3.

FIG. 9 illustrates an exploded view of the base unit of FIG. 7.

FIGS. 10A, 10B, and 10C illustrate overall, and zoomed-in, and side cross-sectional views of the receptacle assembly of FIG. 3.

FIGS. 11A and 11B respectively illustrate overall and zoomed-in perspective cross-sectional views of the receptacle assembly of FIG. 3.

FIGS. 12A, 12B, and 12C illustrate overall, and zoomed-in, and side cross-sectional views of the receptacle assembly of FIG. 2.

FIGS. 13A and 13B respectively illustrate overall and zoomed-in perspective cross-sectional views of the receptacle assembly of FIG. 2.

FIGS. 14A and 14B illustrate overall and top plan views of a user assist.

### DETAILED DESCRIPTION OF CERTAIN EMBODIMENTS

Various receptacle assemblies are described. The receptacle assemblies are described in the context of a trash and/or recycling bin, due to particular utility in that context. However, the embodiments and inventions disclosed herein can also be applied to other types of devices and other environments, such as diaper pails, medical waste bins, or otherwise. No features, structure, or step disclosed herein is essential or indispensable.

### 1. Overview

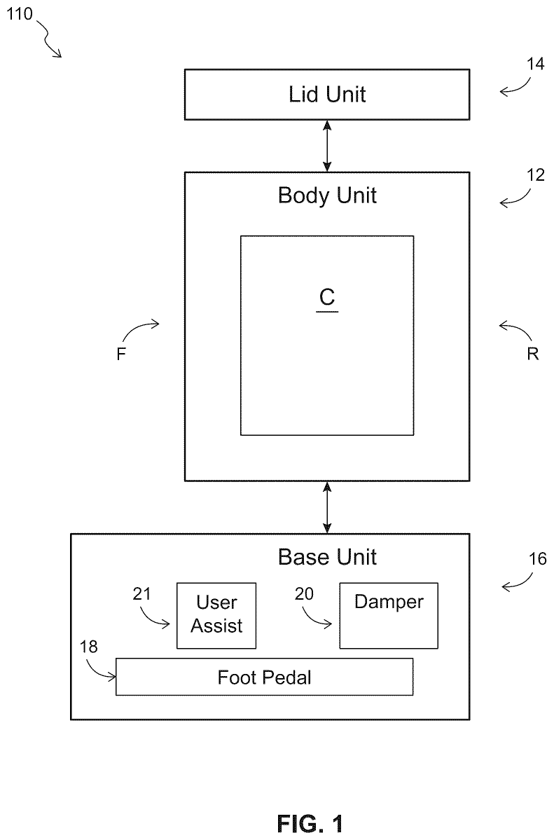

FIG. 1 schematically illustrates an embodiment of a receptacle assembly 10, such as a trash can and/or recycling bin. As shown, the receptacle assembly 10 can include a body unit 12, lid unit 14, and base unit 16. The body unit 12 can have a front F and a rear R, such as a front wall and a rear wall. The body unit 12 can include a chamber C for receiving articles, such as trash. In some embodiments, the body unit 12 includes a plurality of chambers, such as a first chamber (e.g., for trash) and a second chamber (e.g., for recyclables). The containers can be discrete and/or separate such that the types of materials are contained and/or do not mix.

The lid unit 14 can be coupled with the body unit 12. The lid unit 14 can include a lid that can be moved (e.g., pivoted) relative to the body unit 12 between open and closed positions. In certain embodiments, in the open position, the lid is generally vertical, and, in the closed position, the lid is generally horizontal. With the lid in the open position, a user can readily access the chamber C in the body unit 12. With the lid in the closed position, the lid can cover the chamber C. In embodiments with multiple chambers, in the closed position, the lid can extend across and/or cover each of the chambers.

The base unit 16 can be coupled with the body unit 12. As shown, the base unit 16 can include an actuator, such as a foot pedal 18. The foot pedal 18 can be operably connected with the lid unit 14 such that movement of the foot pedal 18 results in movement of the lid 14. For example, the foot pedal 18 can be operably connected with the lid 14 with a linkage, such as a rod, such that depressing the foot pedal 18 opens the lid 14.

As also shown, the base unit 16 can include a motion damper 20. The motion damper 20 can be configured to dampen movement of the lid 14 and/or the foot pedal 18. As schematically illustrated, in some embodiments, the motion damper 20 is positioned near (e.g., adjacent) the rear R of the body unit 12. As also schematically illustrated, a portion of the motion damper 20 can be higher than the foot pedal 18 and/or a portion of the motion damper 20 can be lower than the chamber C. In some embodiments, when a user depresses a front portion of the foot pedal 18, the lid 14 opens; and when the user releases the foot pedal 18, the lid 14 closes and the motion damper 20 dampens movement of the foot pedal 18 and/or the lid 14.

The base unit 16 can include a user assist 21. The user assist 21 can be configured to provide a force that aids in opening the lid 14 and/or depressing the foot pedal 18. In some embodiments, the user assist 21 is a spring or other biasing member, such as a helical coil spring. As schematically illustrated, in some embodiments, the user assist 21 is positioned near (e.g., adjacent) the front F of the body unit 12. In certain variants, the user assist 21 is received at least partly in the foot pedal 18, such as in a recess in the foot pedal 18. In some embodiments, the user assist 21 is compressed by the foot pedal.

Further information about receptacle assemblies can be found in U.S. Pat. No. 10,494,175, issued Dec. 3, 2019, the entirety of which is incorporated by reference herein and any features, structures, or steps from which can be included in any of the embodiments herein.

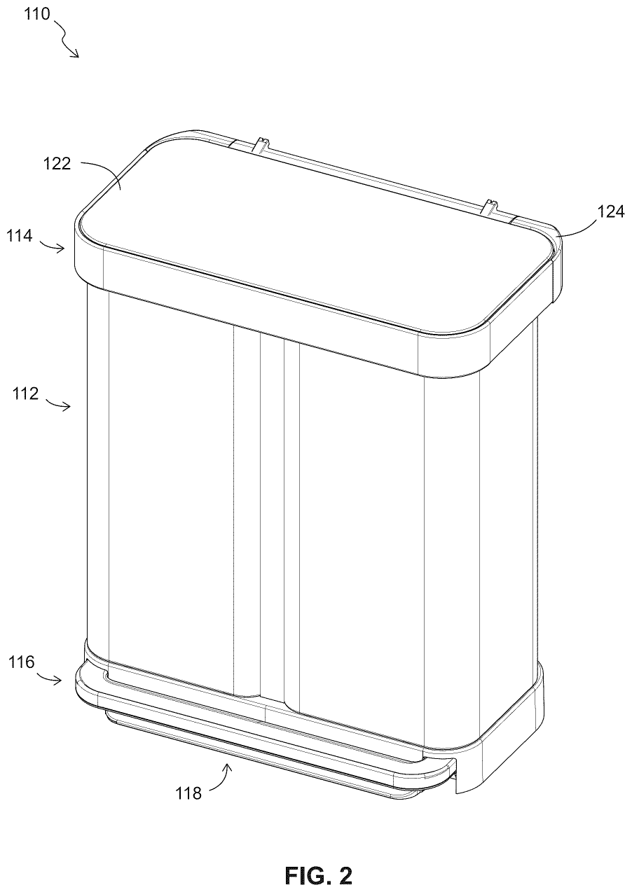

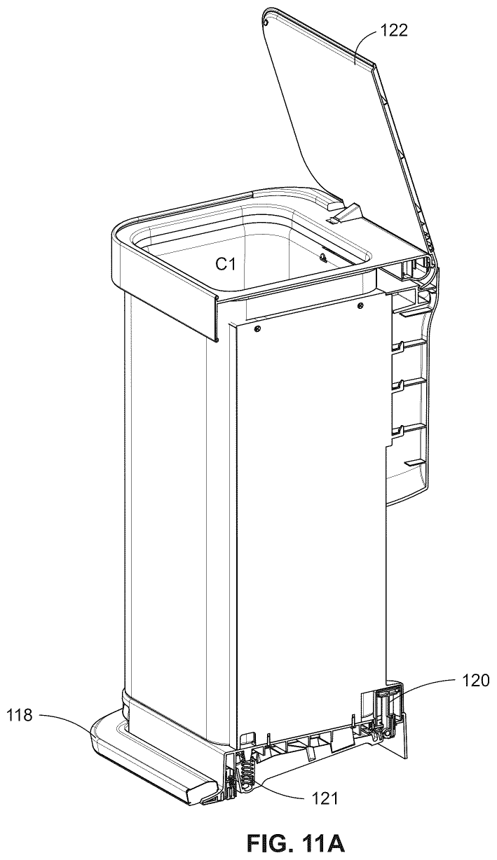

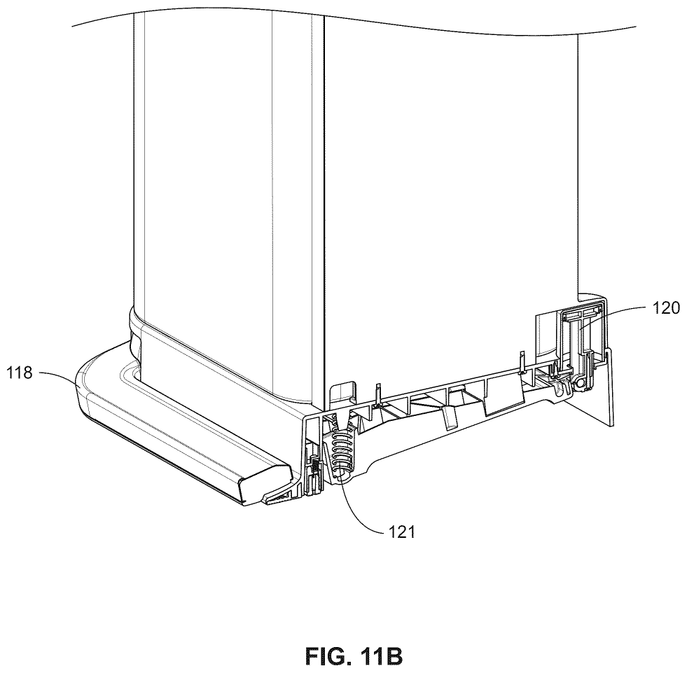

FIGS. 2-13B illustrate another embodiment of a receptacle assembly 110, which can include any combination of the features of the receptacle assembly 10. Many of the features of the receptacle assembly 110 are the same as, or similar to, the features described above in connection with the receptacle assembly 10. To illustrate such correspondence, many of the numerals used to identify features of the receptacle assembly 110 are incremented by a factor of one hundred relative to the numerals used in connection with the receptacle assembly 10. This numbering system is used throughout this specification. Any component or step disclosed in any embodiment in this specification can be used in any other embodiments.

As shown in FIG. 2, the receptacle assembly 110 can include a body unit 112, a lid unit 114, and a base unit 116. The base unit 116 can include a foot pedal 118, a motion damper 120, and a user assist 121. These and other features are described in more detail below.

### 2. Body Unit

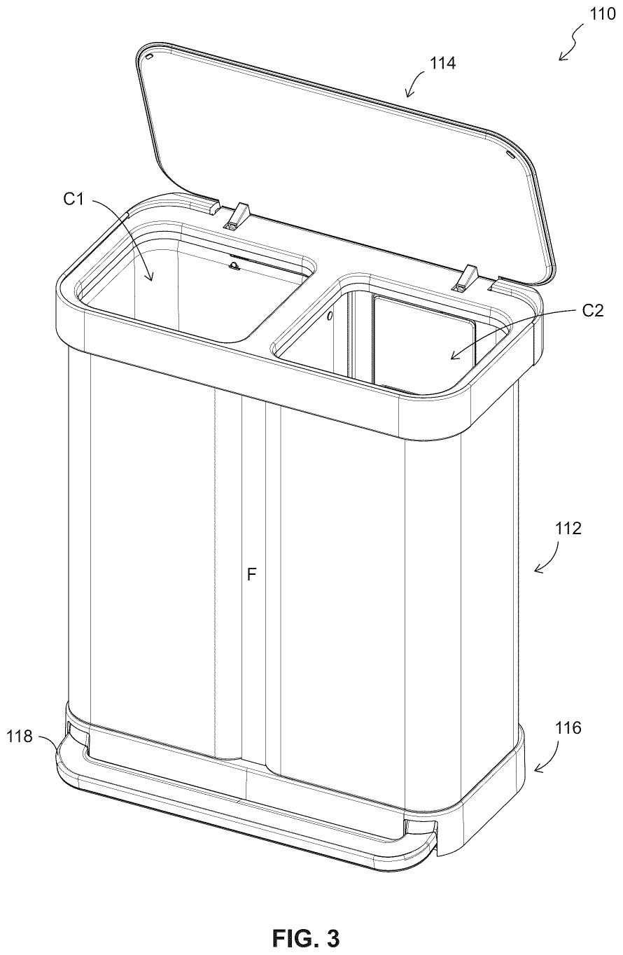

The body unit 112 can include a front wall F, a rear wall R, and a chamber that is configured to receive articles, such as trash. In some embodiments, the front and rear walls are connected by sidewalls. As shown in FIG. 3, in some implementations, the body unit includes a plurality of chambers C1, C2, such as one chamber for trash and another chamber for recycling. In certain implementations, the body unit 112 can have a rectangular shape. Other shapes are also within the scope of this disclosure, such as cylindrical, semi-cylindrical (e.g., rounded in front and generally flat in the rear), right rectangular prismatic, rectangular cuboidal, or rectangular parallelepipedic, etc. In certain embodiments, the body unit 112 is formed of metal (e.g., sheet stainless steel, sheet aluminum, etc.), plastic, or other materials. For example, the body unit 112 can comprise a shell formed of stainless sheet, such as 23 to 26 gauge stainless steel. Further details regarding the body unit 112 and other features can be found in U.S. Pat. No. 9,051,093, issued Jun. 9, 2015, the entirety of which is incorporated by reference herein.

In various embodiments, the body unit 112 has an upper peripheral edge that is configured to engage with a liner, such as a trash bag. For example, some embodiments have a peripheral edge with an outward flange configured to engage with and retain the lip of a trash bag. In certain variants, the peripheral edge comprises a rounded (e.g., rolled-over) metal edge. The trash bag can hang downwardly from the peripheral edge into one of the chambers C1, C2. In some embodiments, the body unit 112 is configured to directly receive the trash bag, without the need for a separate generally rigid liner bucket that fits inside the body unit 112. For example, as described in more detail below, the base unit 116 can have a generally upwardly facing bottom interior surface that can support a bottom of the trash bag.

Some variants include a generally rigid liner bucket, such as a bucket made from hard plastic. The liner bucket can be received in one of the chambers C1, C2 and can include an upper peripheral edge configured to engage with a trash bag. A portion of the trash bag can hang downwardly from the attached upper edge into the liner bucket. In some variants, the liner bucket is configured to contain leaks and/or spills from the trash bag. For example, in some embodiments, a bottom of the liner bucket has no holes visible to a user.

### 3. Lid Unit

The lid unit 114 can include a lid 122 that is moveably coupled with the body unit 112, such as with a hinge. The lid 122 can be configured to pivot relative to the body unit 112. This can enable the lid 122 to rotate into the open position to open the receptacle assembly 110 (e.g., to allow a user to insert trash into a trash bag in one of the chambers C1, C2) and to rotate into the closed position to close the receptacle assembly 110. In various embodiments, in the closed position the lid 122 is at an angle of about 0° (e.g., relative to horizontal) and/or in the open position the lid 122 is at an angle of about 90°. In some embodiments, in the open position, the lid 122 is at an angle of less than about 90°, such as less than or equal to about: 65°, 70°, 75°, 80°, 85°, angles between the aforementioned angles, or other angles. In some embodiments, the lid unit 114, or a part thereof, is made of metal, such as aluminum or stainless steel. In some variants, a part of the lid unit 114 is metal and another part is plastic.

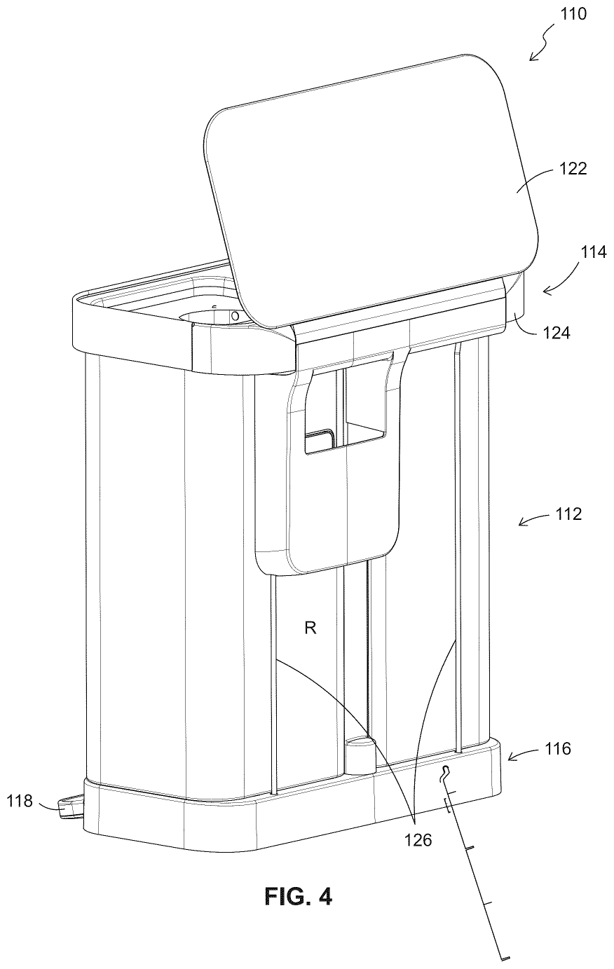

As shown in FIG. 4, the lid unit 114 can include a trim member 124. In some embodiments, the trim member 124 can receive the lid 122 (when in the closed position) and/or can obscure the upper peripheral edge of the body unit 112 (which can be engaged with the trash bag). In some implementations, the trim member 124 is pivotally connected with the rear region R of the body unit 112. For example, the trim member 124 can be pivotally coupled to the rear region R and configured to rotate about a pivot axis in common with the lid 122. The trim member 124 can be made of various materials, such as plastic or metal. The trim member 124 and the body unit 112 can be made from the same or different materials. For example, the trim member 124 and the body unit 112 can comprise a plastic material. In some embodiments, the trim member 124 can engage and/or overlap the upper edge of the body unit 112. Further details regarding the trim member and other features can be found in U.S. Pat. No. 9,790,025, issued Oct. 17, 2017, the entirety of which is incorporated by reference herein.

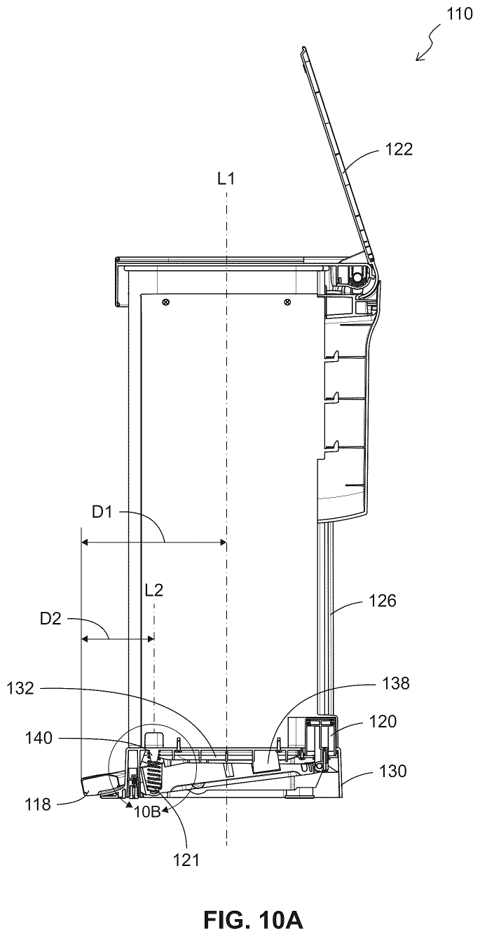

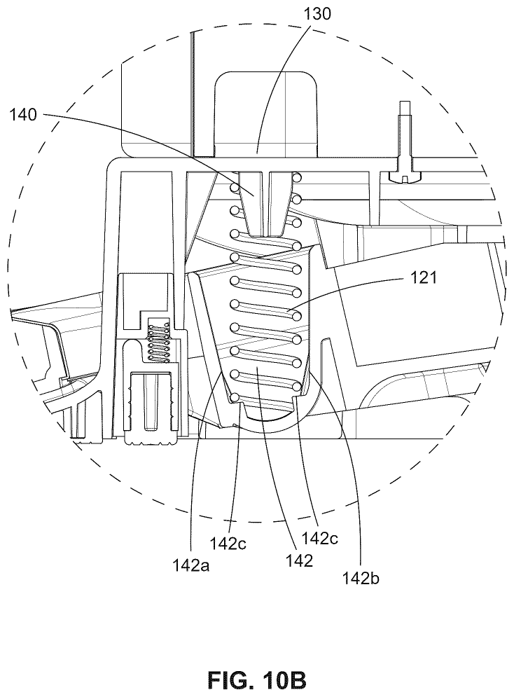

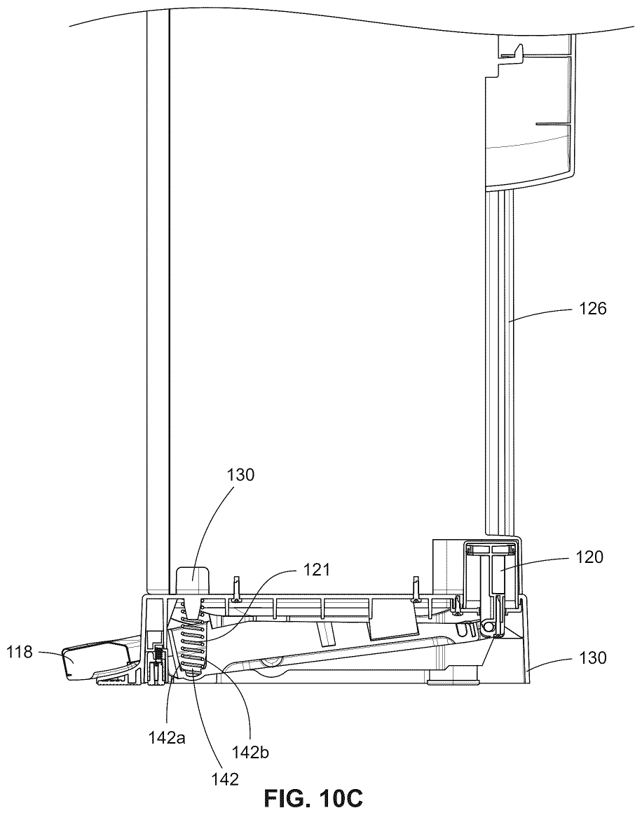

The lid unit 114 can be connected with a force-communicating linkage, such as a rod 126. As illustrated in FIGS. 4 and 10A, the rod 126 can extend from a region at or near the lid unit 114 to a region at or near the foot pedal 118. The rod 126 can include an elongate portion (e.g., a majority of the length of the rod) that is generally parallel to the longitudinal axis of the receptacle assembly 110.

The rod 126 can include an upper portion interfaced with the lid unit 114 and a lower portion interfaced with the foot pedal 118. For example, the upper portion of the rod 126 can engage with an engagement region (e.g., a slotted receiving structure) of the lid 122 and the lower portion can engage with a rear feature (e.g., an aperture) of the foot pedal 118. As described in more detail below, depressing the front portion of the foot pedal 118 can move the rear portion of the foot pedal 118 upward, which drives the rod 126 upward, which in turn drives the lid 122 toward the open position. Releasing the front portion of the foot pedal 118 allows the rear portion of the foot pedal 118 to move downward, which allows the rod 126 to move downward, which in turn allows the lid 122 to move toward the closed position.

In various embodiments, the receptacle assembly 110 is configured such that the rod 126 does not occupy space in the chambers C1, C2 and/or does not engage with a trash bag in the chambers C1, C2. For example, as illustrated, the lower portion of the rod 126 can pass through an opening in the base unit 116 and extend upward external to the body unit 112. As further illustrated, in some embodiments, the entire rod 126 that is higher than the base unit 116 is located external to the body unit 112. In some embodiments, the connection between the rod 126 and the lid unit 114 can be positioned in a rear housing 128 and can be external to the chambers C1, C2. In various implementations, some or all of the rod 126 is located outside of the chambers C1, C2. For example, in some embodiments, no portion of the rod 126, or at least not a majority of the rod 126, is in the chambers C1, C2.

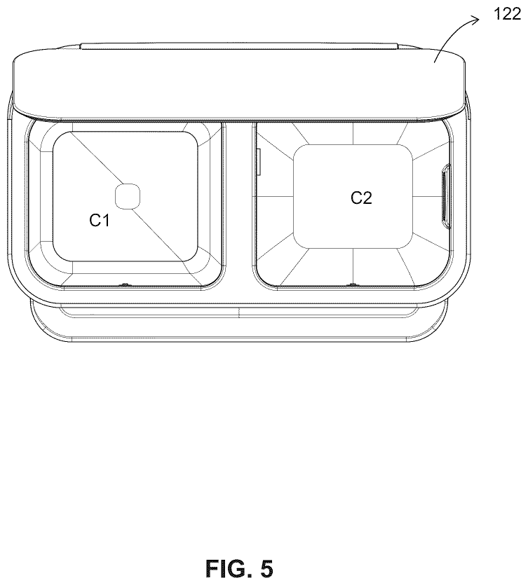

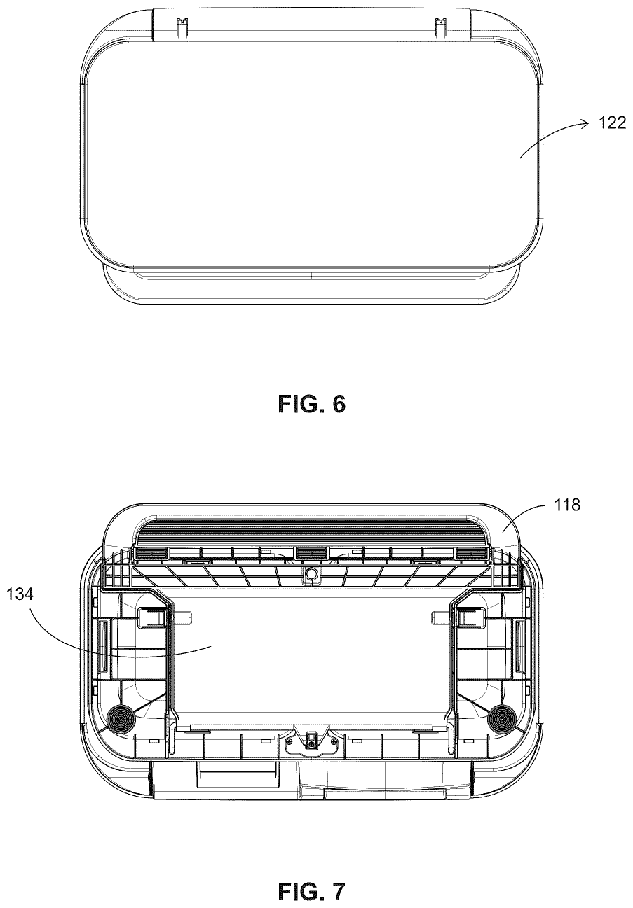

As illustrated in FIGS. 5 and 6, the lid 122 can be one piece extending across the chambers C1, C2. Because the lid 122 covers both chambers C1, C2, this can make the lid 122 relatively large and heavy. In some implementations, the lid weighs at least about 2 lbs. and/or less than or equal to about 5 lbs., has a lateral width of at least about 18 inches and/or less than or equal to about 24 inches, and/or has a front-to-back depth of at least about 8 inches and/or less than or equal to about 14 inches, including any combination thereof. For example, the lid 122 can have a lateral width of at least about 21 inches and a front-to-back depth of at least about 10 inches. In various embodiments, the lateral width of the lid 122 is greater than the sum of the lateral widths of the chambers C1, C2. In certain variants, the lateral width of the lid 122 is at least about 105% of such sum and/or less than or equal to about 125% of such sum.

In some embodiments, the lid 122 can be made at least partly of a metal (e.g., aluminum or stainless steel), which can make the lid 122 particularly heavy. For example, the top surface of the lid 122 can be metal and/or the portion of the lid 122 visible to a user when the lid 122 is closed can be made of metal. In some embodiments, the lid 122 can include one or more metal components that form a majority of the surface area of the lid that is visible from the outside when the lid is closed. In some embodiments, the lid 122 can be made at least partly of a plastic, making the lid 122 lighter than the lid made entirely out of a metal. For example, in some variants, a top and/or external portion of the lid 122 is metal and a bottom and/or or internal portion of the lid 122 is plastic. In certain implementations, the lid 122 includes an outer metal layer over (e.g., wrapped around, extending across, and/or encompassing) an inner plastic structure.

### 4. Base Unit

The receptacle assembly 110 can be configured to rest on the base unit 116. The base unit 116 can be positioned lower than, and configured to support, the body unit 112 and the lid unit 114. The body unit 112 can extend upward from the base unit 116. In some embodiments, the body unit 112 and the base unit 116 are made of different materials, such as the base unit 116 being plastic and the body unit 112 being metal (e.g., aluminum or stainless steel).

### 4A. Upper and Lower Base Portions

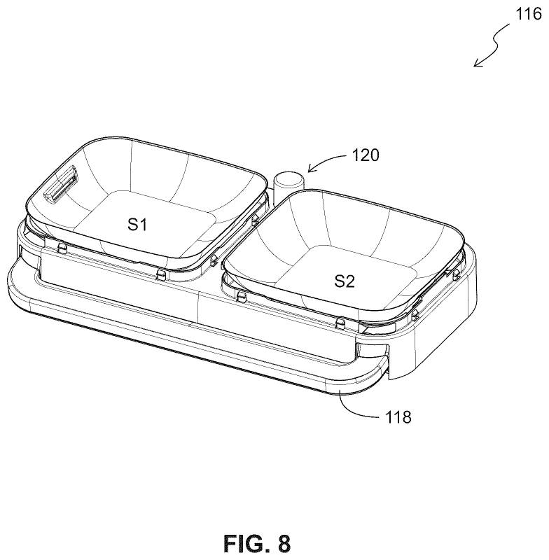

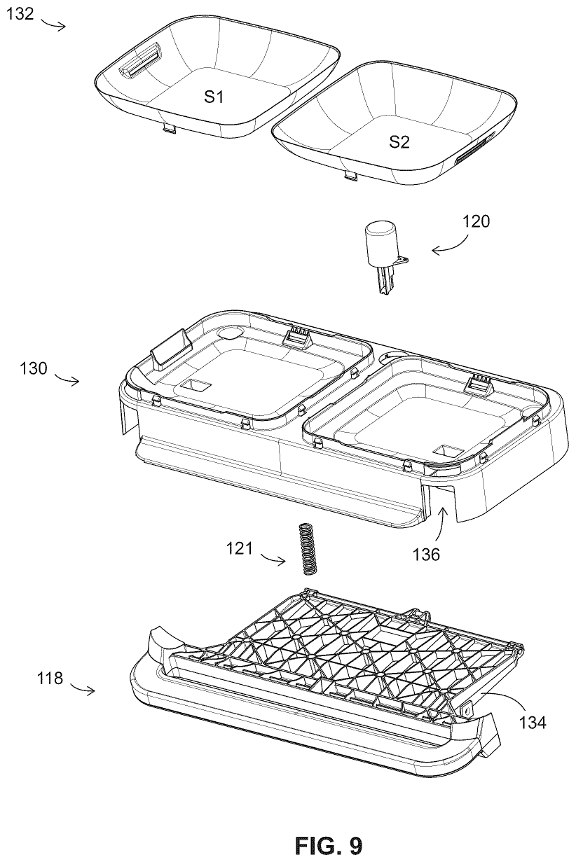

As illustrated in FIGS. 8 and 9, the base unit 116 can include a lower base portion 130 and an upper base portion 132. In some embodiments, the lower base portion 130 and the upper base portion 132 are unitary components (e.g., are integrally formed). In certain variants, the lower base portion 130 and the upper base portion 132 are separate components. The lower base portion 130 and the upper base portion 132 can be connected together, such as with fasteners, mating hooks and slots, or otherwise. The lower base portion 130 can include feet or other features to enable the receptacle assembly 110 to rest stably on a floor or other generally horizontal surface. As described in more detail below, the lower base portion 130 can engage with the foot pedal 118.

The upper base portion 132 can include one or more generally upwardly facing bowl surfaces S1, S2. The surfaces S1, S2 can form the bottom boundary of one of the chambers C1, C2. As shown, the bowl surfaces S1, S2 can be generally concave. For example, as shown, surfaces S1, S2 can comprise a generally sloped or slanted region (e.g., positioned generally on or around the periphery) and/or a generally flat or generally planar region (e.g., positioned generally horizontally in a central or inner area). In some embodiments, the bowl surfaces S1, S2 are free of moving components (e.g., dampers, foot pedal components, cross bars, linkage rods, etc.) and/or substantial bumps, protrusions, recesses, and/or other features that produce appreciable unevenness.

In some embodiments, the bowl surfaces S1, S2 can be configured to support and/or inhibit damage to a trash bag in the chambers C1, C2. For example, the bowl surfaces S1, S2 can be configured to reduce the chance of snagging, rubbing, and/or pinching the trash bag, which could tear or otherwise harm the trash bag. In some embodiments, the bowl surfaces S1, S2 are substantially continuous and/or provide substantially constant support for the bottom of the trash bag from one lateral side of the chambers C1, C2 to an opposite lateral side of the chambers C1, C2. In certain variants, the bowl surfaces S1, S2 are generally smooth, generally continuous, and/or generally unobstructed. In some embodiments, the bowl surfaces S1, S2 facilitate a generally even distribution of articles (such as trash) inside of the trash bag about the interface between the bowl surfaces S1, S2, and the trash bag.

In some embodiments, the height of the lower base portion 130 is less or substantially less than the height of the upper base portion 132. In certain variants, the uppermost surface of the lower base portion 130 is closer to the bottom of the receptacle assembly 110 than to the middle and/or top of the receptacle assembly 110. In some embodiments, the height of the lower base portion 130 is less than or equal to about one-fourth of the height of the upper base portion 132. In certain embodiments, the height of the lower base portion 130 is less than or equal to about one-eighth of the height of the upper base portion 132.

### 4B. Foot Pedal

As previously mentioned, the receptacle assembly can include an actuator, such as the foot pedal 118. In some embodiments, the foot pedal 118 can include a pedal bar 134 that couples with the lower base portion 130, such as is shown in FIGS. 7 and 9. For example, the pedal bar 134 can be pivotally coupled with the lower base portion 130 such that at least the front portion of the pedal bar 134 can be pivoted relative to the lower base portion 130 (e.g., to enable a user to press on and move the front portion of the pedal). As shown in FIGS. 8 and 9, the pedal bar 134 can extend out from a front region of the lower base portion 130 so as to provide access by a user's hand or foot. For example, the pedal bar 134 can extend through apertures 136 in the lower base portion 130. In various embodiments, the foot pedal 118 pivots about an axis at or near the rear of the receptacle assembly 110.

As previously mentioned, the foot pedal 118 can be operatively connected with the lid unit 114 with a linkage, such as the rod 126. When the foot pedal 118 is moved from a resting position to an actuated position, the lid 122 can be moved from the closed position to the open position. As used herein, the term “resting position” refers to a position in which the foot pedal 118 normally resides when not being actuated by a user, such as when a front portion of the foot pedal 118 is pivoted towards an upper position. As used herein, the term “actuated position” refers to a position in which the pedal 118 is located during or upon completion of actuation by a user, such as when a front portion of the foot pedal 118 is pressed downward by a user. In various embodiments, in response to the front portion of the foot pedal 118 being depressed, the rear portion of the pedal bar 134 can pivot upward, which can move the rod 126 generally upward, which in turn can drive the lid 122 toward the open position. In various embodiments, in response to the front portion of the foot pedal 118 being released, the weight of the lid unit 114 can encourage the lid 122 to move toward the closed position, which can move the rod generally downward, which in turn can pivot the rear portion of the pedal bar 134 downward and/or the front portion of the pedal bar 134 upward.

In certain implementations, the lid 122 and/or the foot pedal 118 are biased toward the closed and resting positions, respectively, by way of various devices or configurations. For example, the force of gravity and/or the weight of the lid 122 can encourage the lid 122 toward the closed position, such as when a user has released the pedal 118 or otherwise is applying substantially no downward force on the foot pedal 118. Some embodiments include springs or other force-providing members to bias the lid 122 toward the closed position, and/or the foot pedal 118 to the resting position, as discussed further herein.

As shown in FIG. 10A, the pedal bar 134 can include a movement control element, such as a stop block 138. The stop block 138 can be located on the rear portion of the pedal bar 134. When the foot pedal is depressed, the stop block 138 can engage with (e.g., abut against) the upper base portion 132, which can inhibit or prevent further upward movement of the rear portion of the pedal bar 134. In some embodiments, the movement control element includes a dampening feature, such as a rubber bumper, which can reduce the impact with which the stop block 138 contacts the upper base portion 132 and/or can reduce the amount of noise created by such impact.

Certain implementations of the receptacle have an electronic lid actuation mechanism instead of or in addition to the foot pedal. For example, certain implementations have a motor that moves the lid 122. The motor can be powered by a power source, such as a battery or plug for external electric power. In some variants, the receptacle includes a sensor, such as a proximity sensor. The sensor can detect movement and/or the presence of a user and, in response, the motor can be actuated to open the lid 122. An electronic controller (e.g., processor and memory) can govern operation of the sensor and motor. The user assist can reduce the amount of force needed to be applied by the motor, thereby allowing for a smaller motor, extending motor and/or battery life, reducing power usage, and/or increasing efficiency.

### 4C. Motion Damper

As shown in FIGS. 8, 9, and 10A-13B, the base unit 116 can include the motion damper 120. In several embodiments, the motion damper 120 is located at or near the rear of the base 130. For example, the motion damper 120 can be positioned in an opening in a rear of the lower base 130. As shown, in some implementations, the motion damper 120 is about laterally centered in the receptacle assembly 110 (e.g., about midway between the sidewalls). The motion damper 120 can be any type of dampening device, rotary dampening device, friction dampening device, fluid dampening device with liquid or gaseous working fluids (e.g., an air damper), biasing member (e.g., a spring), or otherwise. In some embodiments, the motion damper 120 comprises a linear dampening device, such as a device than extends and contracts along a straight line. In some embodiments, the motion damper 120 comprises a single-directional fluid (e.g., air or hydraulic) damper that is configured to slow down linear movement before reaching a final position and/or to provide a controlled return to a starting position. The motion damper 120 can include a housing with an inner cavity, a piston that reciprocates in the cavity, and a connecting rod coupled with the piston. Fluid pressure in the cavity can inhibit movement of the piston, thereby providing a dampening influence. In various embodiments, the motion damper 120 is operably connected with the foot pedal 118, such as with a pinned connection and/or at or near a rear of the foot pedal 118. Further details about certain implementations of the motion damper 120 and other features can be found in U.S. Pat. No. 8,418,869, issued Apr. 16, 2013, the entirety of which is hereby incorporated by reference herein.

The motion damper 120 can be configured to dampen and/or regulate the movement of one or more of the components of the receptacle assembly 110. For example, the motion damper 120 can dampen (e.g., slow and/or control) movement of the lid 122 between the open and closed positions, such as from the open position toward the closed position and/or from the closed position toward the open position. In some embodiments, when the lid 122 is in the open position and the user releases the front portion of the foot pedal 118, the weight of the lid 122 and/or the front portion of the foot pedal 118 can encourage the lid unit 114 to move toward the closed position. This can cause the rod 126 to move, which can cause the motion damper's piston to move in the chamber and be inhibited by fluid pressure or other force, thereby causing the lid and/or foot pedal's movement to be dampened. Such dampening can be transmitted, via the rod 126, to the lid unit 114. This can provide graceful and controlled movement of the lid 122 and/or can reduce or eliminate an audible noise (e.g., clanging) when the lid 122 closes against the body unit 112.

In certain embodiments, the motion damper 120 is a one-way damper, which provides dampening in only one direction. For example, in some embodiments, the motion damper 120 provides dampening only during a closing movement of the lid 122. In certain variants, the motion damper 120 provides dampening only during an opening movement of the lid 122. In some variants, the motion damper 120 is a two-way damper, which provides dampening when the lid 122 is moved from the closed position toward the open position and from the open position toward the closed position. In some implementations, the motion damper 120 is configured to provide more resistance (e.g., dampening force) when the lid 122 is being closed than when the lid 122 is being opened.

### 4D. User Assist

As shown in FIGS. 10A-10C, the base unit 116 can include the user assist 121. The user assist 121 can comprise a force-producing structure, such as a spring, actuator, or otherwise. As discussed in more detail below, the user assist 121 can help a user actuate (e.g., depress) the pedal 118 and/or open the lid 114, such as by compensating for at least some of the weight of the lid 114.

A first (e.g., upper) end of the user assist 121 can be engaged with the lower or upper base portion 130, 132 and a second (e.g., lower) end of the user assist 121 can be engaged with the foot pedal 118. For example, the first end of the user assist 121 can be engaged with an upper wall of the lower base portion 130 and/or the second end of the user assist 121 can be received in a recess 142 in the foot pedal 118. In certain embodiments, when the foot pedal 118 is in the resting position, a majority of the user assist 121 is received in the recess 142 in the foot pedal 118. In some implementations, in a vertical plane intersecting the certain, lower base portion 130, and foot pedal 118, the user assist 121 is positioned between the lower base portion 130 and foot pedal 118. For example, the user assist 121 can be compressed between and/or sandwiched by the lower base portion 130 and foot pedal 118. As shown, in some embodiments, the first end of the user assist 121 can be received on a projection 140 (e.g., a boss, cone, pin, etc.) on the lower base portion 130. The projection 140 can secure and/or retain the first end of the user assist 121.

As illustrated in FIG. 10A, the user assist 121 can be positioned above the foot pedal 118. For example, as shown in FIG. 10B, a zoomed-in view of FIG. 10A, a lowest portion (e.g., the second end) of the user assist 121 can be above a portion (e.g., the bottom of the recess 142) of the foot pedal 118 and/or an upper portion (e.g., the first end) of the user assist 121 can be positioned below a portion (e.g., a substantially planar portion) of the lower base portion 130. In certain variants, the user assist 121 does not engage the rod 126, such as via a bracket. In some embodiments, the user assist 121 directly engages the foot pedal 118. For example, the user assist 121 can directly apply force to and/or dampen movement of the foot pedal 118, rather than applying force to an/or dampening movement of the rod to indirectly apply force to and/or dampen movement of the foot pedal 118. In various implementations, the user assist 121 pushes against or pulls on the pedal 118. For example, the user assist 121 can apply a pushing force on the pedal 118 in a generally downward direction and/or a direction generally parallel with the longitudinal axis of the receptacle assembly 110. In some variants, the user assist 121 can apply a pulling force on the pedal 118 in a generally upward direction and/or a direction generally parallel with the longitudinal axis of the receptacle assembly 110.

In some embodiments, the first end (e.g., upper) of the user assist 121 remains substantially stationary relative to the lower base portion 130 and the second end of the user assist 121 is configured to move relative to the foot pedal 118. For example, when the foot pedal 118 is depressed by a user, the second end of the user assist 121 can slide along a portion of the recess 142 in the foot pedal 118. In certain variants, the second end of the user assist 121 remains substantially stationary relative to the foot pedal 118 and the first end of the user assist 121 is configured to move relative to the lower base portion 130. In some embodiments, one or both ends of the user assist 121 and/or the bottom of the recess 142 are rounded (e.g., hemispherical). This can facilitate movement of the user assist 121 relative to the foot pedal 118. In some embodiments, as the foot pedal 118 is depressed, the user assist 121 bends. For example, in certain implementations, in response to the pedal 118 being depressed, the first and second ends of the user assist 121 change from co-linear to non-colinear and/or a longitudinal axis of the user assist 121 changes from straight to curved.

As shown, the recess can have a front wall 142a, a rear wall 142b, and a bottom. In some embodiments, the bottom of the recess 142 includes a ledge 142c that receives the second (e.g., bottom) end of the user assist 121. In some embodiments, as the foot pedal 118 is depressed, the front wall 142a of the recess 142 can become less parallel to the longitudinal axis of the user assist 121 and/or the rear wall 142b can become more parallel to the longitudinal axis of the user assist 121. In some embodiments, as the foot pedal 118 is released, the front wall 142a of the recess 142 can become more parallel to the longitudinal axis of the user assist 121 and/or the rear wall 142b can become less parallel to the longitudinal axis of the user assist 121. In some embodiments, the front wall 142a and the rear wall 142b are not parallel to each other. For example, in certain implementations, the recess can have a trapezoidal or frustoconical shape.

In some embodiments, when the foot pedal 118 is in the resting position, the user assist 121 is substantially completely bounded by the foot pedal 118 and the lower base portion 130. For example, the user assist 121 can be completely or substantially completely enclosed within, surrounded by, and/or encapsulated between the foot pedal 118 and the lower base portion 130. The user assist 121 being substantially completely bounded can support the user assist 121, maintain the user assist 121 in position, protect the user assist 121 from dirt and damage, and/or aid in hiding the user assist 121 from view.

In some embodiments, the user assist 121 is positioned between the lower base portion 130 (e.g., the projection 140) and the bottom of the recess 142. For example, the user assist 121 can span the length between the projection 140 and the bottom of the recess 142. The user assist 121 can be configured to expand and contract to adjust for movement of the pedal 118. For example, when the front portion of the foot pedal 118 is depressed by a user, the front portion of the foot pedal 118 pivots downward. This can move the front portion of the foot pedal 118 away from the lower base portion 130, which moves the bottom of the recess 142 away from the lower base portion 130 (e.g., the projection 140). The user assist 121 can expand and/or increase in length a corresponding amount to continue to span between the recess 142 and the lower base portion 130. The user assist 121 can apply a force to the pedal 118 (such as because the user assist 121 is not in a free state), which urges the pedal 118 down. This can help the user depress the pedal 118 and/or provide a pleasantly surprisingly light feel to operation of the receptacle assembly 110, such as because the user does not need to apply the full force needed to open the lid 122. In several embodiments, the user assist 121 applies force to the pedal 118 throughout a majority, at least about 90%, or the entire movement of the pedal 118 from the resting position to the actuated position.

In some embodiments, the amount of force applied by the user assist 121 to the pedal 118 varies as a function of the travel of the pedal 118. For example, the force provided by the user assist 121 can increase or decrease (e.g., linearly or non-linearly) with travel of the pedal 118. In some embodiments, the user assist 121 is configured to provide more force to the pedal 118 during an initial stage of pedal travel (e.g., less than or equal to about the first 33%) and less force during a later stage of travel (e.g., after the first 33%). In certain embodiments, the user assist 121 is a spring with a spring rate that varies as the spring is deflected, such as a spring rate that increases or decreases with deflection distance. For example, the user assist 121 can be a progressive rate spring, dual rate spring, triple rate spring, or other variable rate spring.

When the front portion of the foot pedal 118 is released by a user, the front portion of the foot pedal 118 can pivot upward, which moves the front portion of the foot pedal 118 toward the lower base portion 130 and moves the bottom of the recess 142 toward the lower base portion 130 (e.g., the projection 140). The user assist 121 can compress and/or decrease in length (e.g., compress) a corresponding amount to continue to span between the recess 142 and the lower base portion 130. The user assist 121 can apply a force to the pedal 118, which urges the pedal 118 down. This can provide a dampening action that slows movement of the pedal 118 and/or lid 122 to the resting position.

The user assist 121 can be located near the front wall F of the receptacle assembly 110 and near the bottom of the receptacle assembly 110 (e.g., in the base 130). For example, as shown in FIGS. 10A and 10C, the user assist 121 can be positioned closer to a front wall of the body portion than to a rear wall of the body portion. The user assist 121 can be positioned adjacent or directly adjacent the front wall of the body portion. In certain embodiments, the user assist 121 is positioned closer to the frontmost portion of the foot pedal 118 than the rearmost portion of the foot pedal 118. As a function of the front-to-rear width of the body unit 112, the user assist 121 can be located in the front half, front third, front quarter, front eighth, front sixteenth, or otherwise. In some implementations, the user assist 121 is not connected with a rear portion of the receptacle assembly, such as not being fastened to a rear wall of the body unit 112. In certain variants, the user assist 121 is not located in, and/or does not extend into, the chambers C1, C2. In some embodiments, the user assist 121 is not connected to a top of the base unit 116 and/or is not exposed in the chambers C1, C2. In some implementations, the user assist 121 is located inside the base unit 116 and/or is not positioned on an exterior surface of the receptacle assembly 110. In various embodiments, as illustrated in FIG. 10B, the user assist 121 does not protrude into the lower base portion 130, the lower base portion 130 does not include a cavity that receives the upper end of the user assist 121, and/or the lower base portion 130 is planar above the user assist 121.

As shown in FIG. 10A, the user assist 121 can be positioned frontward of a center of the receptacle assembly 110. In some embodiments, the receptacle assembly 110 can have a longitudinal axis L1 (which is spaced apart from the frontmost portion of the foot pedal 118 by a distance D1) and the user assist 121 can have a longitudinal axis L2 (which is spaced apart from the frontmost portion of the foot pedal 118 by a distance D2). The distance D1 can be substantially greater than the distance D2. For example, the ratio of D1 to D2 can be at least about: 2.0, 2.25, 2.5, 2.75, 3.0, ratios between the aforementioned ratios, or other ratios. With the pedal 118 in the resting position, the longitudinal axis L2 of the user assist 121 can be generally parallel with the longitudinal axis L1 of the receptacle assembly 110. In some variants, the longitudinal axis L2 is less than or equal to about 5° from exactly parallel with the longitudinal axis L1. In certain embodiments the distance between the user assist 121 and the front wall F of the body 112 is less than or equal to the distance from the front of the foot pedal 118 to the front wall F of the body 112. In some embodiments, the distance between the user assist 121 and the front wall F of the body 112 is less than or equal to the distance from the top of the foot pedal 118 to the bottom of the base unit 116 and/or the amount of travel of the front of the foot pedal 118 between the resting and actuated positions.

Locating the user assist 121 near the bottom of the front F of the receptacle assembly 110 can have certain benefits. For example, compared to some trash cans with a spring located at a top rear (e.g., on a rear wall and near the lid of the trash can), locating the user assist 121 near the bottom front F of the receptacle assembly 110 can facilitate compensating for the weight of the lid, efficiently apply force to the pedal 118 to aid the user, protect the user assist 121, hide the user assist 121 from view, and/or lower the receptacle assembly 110's center of gravity.

In some embodiments, the user assist 121 is located in a lateral middle region of the receptacle assembly 110. For example, the user assist 121 can be located on or near a midpoint of the distance between lateral sidewalls of the body unit 112. The user assist 121 can be positioned at or near a lateral middle of the foot pedal 118, such as a lateral middle of a front support section that is contained within the lower base portion 130. This can reduce twisting or rocking of the foot pedal 118 during dampening, facilitate protecting the user assist 121, or otherwise. As shown in FIG. 9, the front support section, or other portions of the foot pedal 118, can include reinforcement members, such as ribs, struts, or otherwise. In some variants, from a top plan view, the reinforcement members form spaces that are hexagonal, rectangular, triangular, or another shape. This can reduce the weight of, and/or the amount of material in, the foot pedal 118.

Certain embodiments are configured to protect, conceal, or obscure the user assist 121. For example, the user assist 121 can be positioned entirely inside the base unit 116, which can shield the user assist 121 and reduce the chance of the user assist 121 being damaged. As mentioned above, the user assist 121 can be located under the upper base portion 132 and/or the lower base portion 130. This can protect (e.g., shield) the user assist 121 from damage when trash is thrown into a trash bag in the chambers C1, C2. In some embodiments, the user assist 121 is not visible to, and/or accessible by, a user during normal use of the receptacle assembly 110. For example, the user assist 121 is hidden when the receptacle assembly 110 is viewed from the external front, rear, side, and top (see, e.g., FIGS. 2-6). In certain embodiments, the user assist 121 is hidden when a user looks down into the interior of the chambers C1, C2 (see FIG. 5), such as when the user is removing and/or replacing the trash bag. Thus, in some embodiments, the user assist 121 is hidden both internally and externally.

As illustrated, some embodiments include a single user assist 121. Some embodiments include a plurality of user assists 121, such as two, three, four, or more. For example, certain variants have a first user assist on a first lateral side of the foot pedal 118 and a second user assist on a second lateral side of the foot pedal 118. Certain embodiments have multiple user assists positioned within the footprint of the foot pedal 118. For example, a plurality of user assists can be located on a front-to-rear centerline of the foot pedal 118. Certain embodiments include a first user assist on a first lateral side of the base unit 116 and a second user assist on a second (e.g., opposite) lateral side of the base unit 116. Some variants have a first user assist on a front side of the base unit 116 and a second user assist on a rear side of the base unit 116.

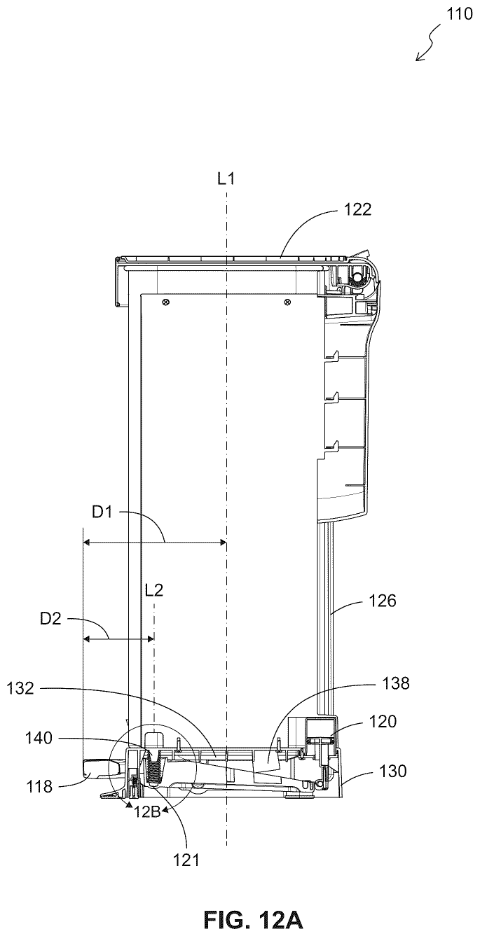

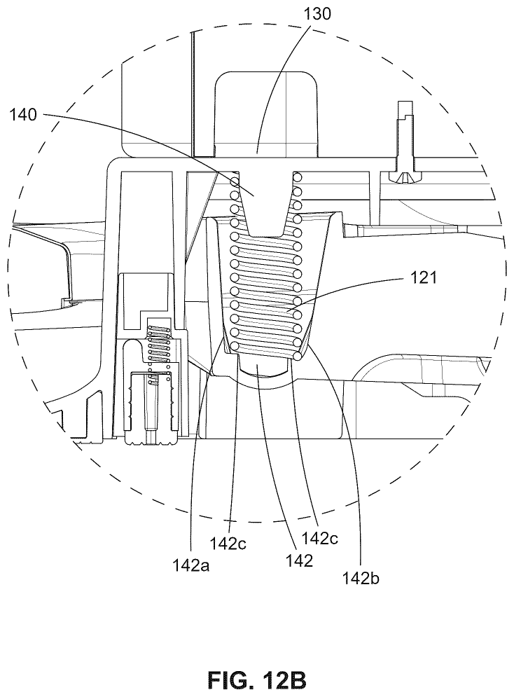

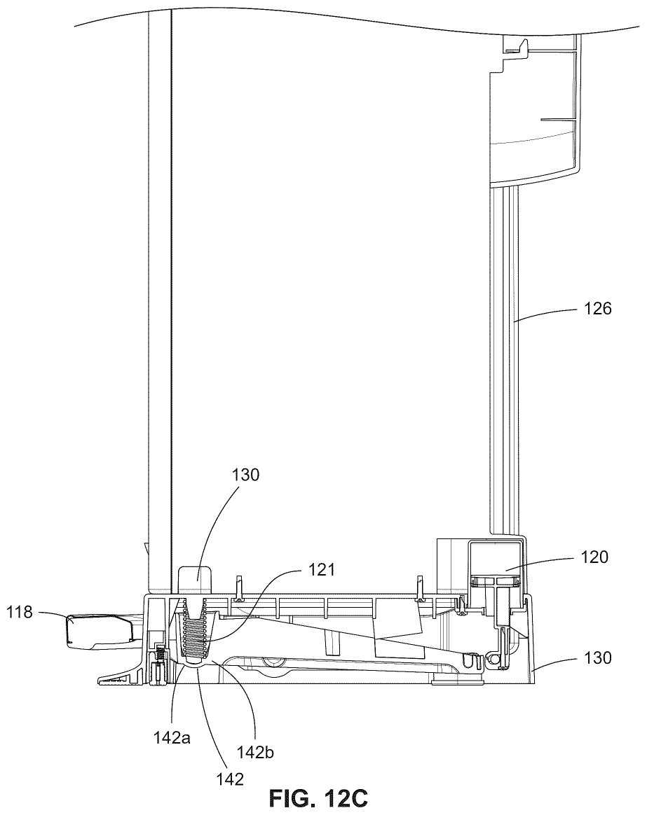

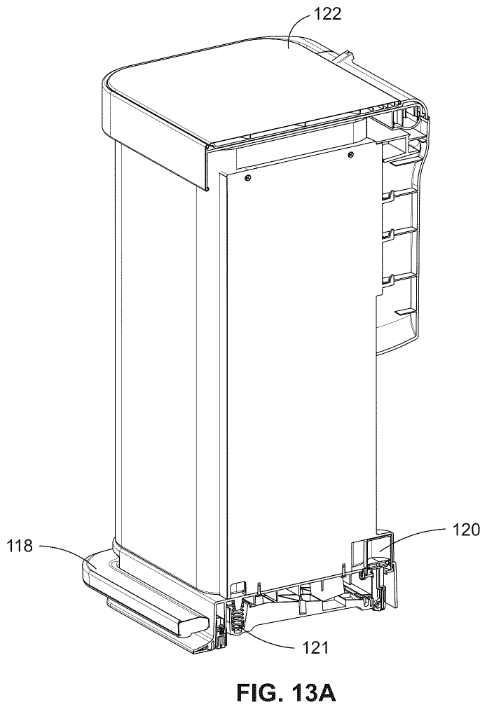

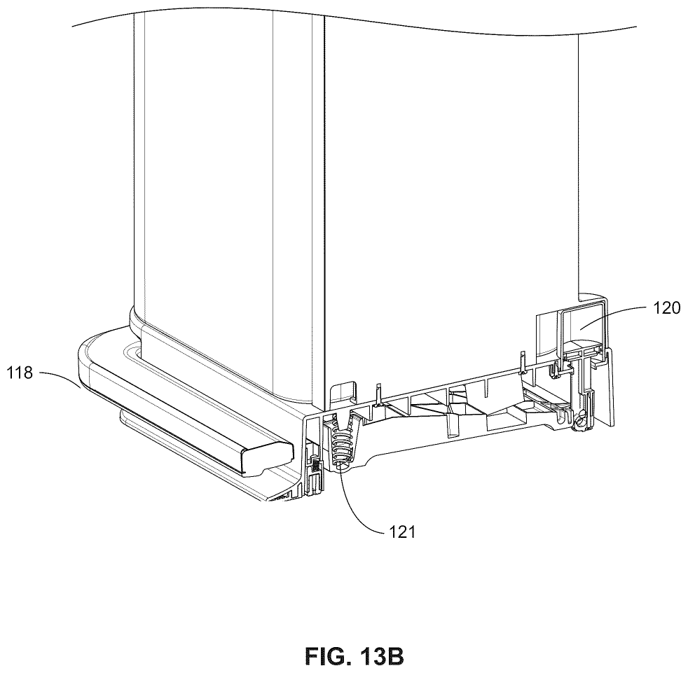

As illustrated in FIGS. 12A-13B, when the front portion of the foot pedal 118 is released by a user, the front portion of the foot pedal 118 can pivot upward. This can move the front portion of the foot pedal 118 toward the lower base portion 130 and the bottom of the recess 142 toward the lower base portion 130 (e.g., the projection 140). As a result, the user assist 121 can be decrease in length and/or be compressed. For example, the user assist 121 can be compressed between the lower base portion 130 and a portion of the pedal 118, such as the bottom of the recess 142. The compression can convert kinetic energy of the pedal 118 into potential energy in the user assist 121. The energy can be stored in the user assist 121. The stored energy can be available to be deployed for assisting in subsequent actuations of the pedal, as discussed above. In various embodiments, in the compressed state, the user assist 121 continues to span between the recess 142 and the lower base portion 130.

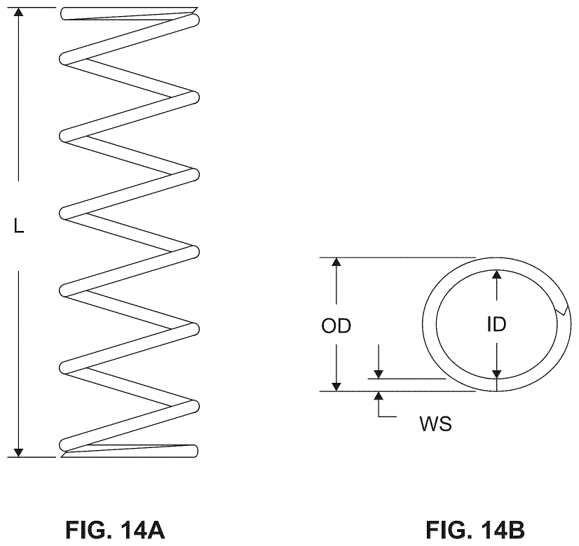

As illustrated in FIGS. 14A and 14B, the user assist 121 can be a force-producing member. For example, the user assist 121 can comprise a helical coil spring, wave spring, leaf spring, conical spring, gas spring, or other type of spring. In some implementations, the user assist 121 is a helical coil spring having a part number 71800 or 71788, available from the Century Spring Company. In some implementations, the user assist 121 comprises an air or liquid damper, bumper, electric actuator, or otherwise. In some embodiments, the user assist 121 can have one or both ends that are closed and/or generally flat, as illustrated. In some embodiments, the user assist 121 can have ends that are open and/or are not flat, such as terminating at an end of a wire. In some embodiments, the user assist 121 can be comprised of metal (e.g., steel), plastic (e.g., polypropylene), or rubber.

The user assist 121 can have an outer diameter (OD). In some embodiments, the OD can be at least about 0.1″ and/or less than or equal to about 1.1″. In some embodiments, the OD can be between about 0.2″ and about 0.9″ and/or between about 0.4″ and about 0.7″. In some embodiments, the OD is at least about 0.6″.

The user assist 121 can have a wire diameter (WD). In some embodiments, the WD can be at least about 0.01″ and/or less than or equal to about 0.134″. In some embodiments, the WD can be between about 0.02″ and about 0.114″, between about 0.04″ and about 0.094″, and/or between about 0.06″ and about 0.074″. In some embodiments, the WD can be at least about 0.067″ or at least about 0.072″.

The user assist 121 can have a free length (L). The free length L is the size (e.g., length) of the user assist 121 in an undeflected (e.g., rest or relaxed) state. For example, in an embodiment in which the user assist 121 is a compression spring, the free length L is the compression spring's uncompressed longitudinal length. In some embodiments, the free length L of the user assist 121 can be at least about 1.0″ and/or less than or equal to about 4.0″. In some embodiments, the free length L of the user assist 121 can be between about 1.5″ and about 3.5″ and/or between about 2.0″ and about 3.0″. In some embodiments, the free length L is at least about 2.5″. In various embodiments, the free length L of the user assist 121 is greater than or equal to the length between the foot pedal 118 (e.g., the bottom of the recess 142) and an upper wall of the lower base portion 130 (e.g., the projection 140) when the pedal 118 is in the resting and/or actuated position.

The user assist 121 can have a spring rate (R). In some embodiments, the spring rate of the user assist 121 can be at least about 0.5 lb./inch and/or less than or equal to about 43.5 lbs./inch. In some embodiments, the spring rate can be between about 5 lb./inch and about 39 lbs./inch, between about 9.5 lbs./inch and about 34.5 lbs./inch, between about 14 lbs./inch and about 30 lbs./inch, and/or between about 18.5 lbs./inch and about 25.5 lbs./inch. In some embodiments, the spring rate of the user assist 121 can be between about 5 lb./inch and about 27 lbs./inch., between about 9.5 lbs./inch and about 22.5 lbs./inch, and/or between about 14 lbs./inch and about 18 lbs./inch. In some embodiments, the spring rate can be at least about: 14 lbs./inch, 16 lbs./inch, 18 lbs./inch, 20, or about 22 lbs./inch 22 lbs./inch, 24 lbs./inch, or otherwise.

The user assist 121 can have a solid height. In some embodiments, the solid height of the user assist 121 can be at least about 0.5″ and/or less than or equal to about 1.52″, and/or between about 1.0″ and about 1.02″. In some embodiments, the solid height SH can be at least about: 0.5″, 1.0″, or 1.5″, plus or minus 0.25″. In some embodiments, the solid height is at least about 0.92″ or at least about 1.01″.

The user assist 121 can include a plurality of coils, such as 8, 11, 14, 17, 20, or more coils. In certain embodiments, the user assist 121 has at least 9 coils and/or less than 18 coils. In some embodiments, the user assist 121 has about 14 coils.

In several implementations, the lid 122 and/or the foot pedal 118 can be biased toward the closed and resting positions. For example, the force of gravity and/or the weight of the lid 122 can encourage the lid 122 toward the closed position, such as when a user has released the pedal 118 or otherwise is applying substantially no downward force on the foot pedal 118.

In some embodiments, the receptacle system 110 balances and/or calibrates various forces within the system to provide easy opening and quiet closing of the lid 122 using the foot pedal 118. As previously discussed, the foot pedal 118 can be operably connected with the lid 122 with the rod 126, such that depressing the foot pedal 118 opens the lid 122. Opening the lid 122 can require that motivating forces F_{M} (e.g., the combination of forces contributed by the user assist 121 and the user) applied to the pedal 118 be greater than or equal to resisting forces F_{R} (e.g., the combined force from the weight of the lid 112, foot pedal 118, and rod 126, any resistance force (e.g., a calibrated, selected, and/or known resistance force) from the motion damper 120, frictional forces, etc.). In other words, F_{M}≥F_{R}. In certain implementations, such as depending on a location of a fulcrum or pivot of the pedal 118, a portion of the weight of the pedal 118 can be a part of the motivating forces and a portion of the weight of the pedal 118 can be a part of the resisting forces. The motivating forces F_{M} can include a force provided by the user and a force provided by the user assist F_{UA} (e.g., F_{M} can equal the sum of Fu and F_{UA}). In certain implementations, the components that provide the resisting forces F_{R} and the components that provide the user assist motivating force F_{UA} are selected such that the lid moves from the covered (e.g., closed) position to the uncovered (e.g., open) position in response to the user applying a force Fu on the foot pedal that is less than or equal to about: 100 N, 90 N, 80 N, 70 N, 60 N, 50 N, or otherwise. In certain implementations of the receptacle system 110, the lid 122 opens in response to the user applying a force Fu on the foot pedal that is less at least about 68 N and/or less than or equal to about 78 N. In certain embodiments, the lid 122 opens in response to the user applying a force Fu on the foot pedal that is less than the weight of the lid and/or pedal. In some variants of the receptacle system 110, the lid 122 opens in response to the user applying a force Fu on the foot pedal that is less than about 100 N, between about 70 N and about 80 N, or between about 71 N and about 75 N. A force of about 75 N (e.g., plus and minus about 5 N) can be beneficial as sufficiently large to reduce or avoid unintentional opening of the lid while also small enough to be comfortable for an average adult person to apply.

Because the user assist 121 can contribute to the motivating force, the amount of force (e.g., on an absolute and/or percentage basis) needed to be contributed by the user can be reduced. The user assist 121 can supplement the user's force to overcome the weight and other resisting forces and open the lid 122. For example, in certain variants, the user assist 121 enables the user to open a large heavy metal lid 122 with a reduced amount of user-force applied to the foot pedal 118 compared to the amount of user-force that would be required without the user assist 121. For example, the reduction in the amount of user-force required can be at least about: 10%, 25%, 50%, or more. In several embodiments, as a percentage of the motivating force needed to open the lid 122, the user assist 121 provides at least about: 25%, 50%, 75%, 90%, or more. In various embodiments, with the lid 112 closed and/or the pedal 118 in the resting position, the user assist 121 alone does not provide sufficient force to overcome the resisting forces and/or a force input from the user is necessary to overcome the resisting forces. This can inhibit or prevent the unintentional opening of the lid 122 (e.g., without user input).

Locating the motion damper 120 and/or the pivot axis of the pedal 118 near the rear wall of the receptacle assembly 110 and the user assist 121 near the front wall of the receptacle 110, can be advantageous. For example, locating the user assist 121 near the front wall can increase the percentage of the motivating forces contributed by the user assist 121 and/or can decrease the percentage of the motivating forces that the user needs to apply to depress the foot pedal 118 and open the lid 112. A short distance between the user assist 121 and the front wall of the receptacle 110 can reduce the amount of user-provided force, or allow the user to apply minimal force, to open the heavy lid 122. Locating the motion damper 120 and/or the pivot axis of the pedal 118 on the opposite end of the foot pedal 118 as the user assist 121 can increase the length of travel of the motion damper 120 as the lid 122 moves between the open and closed positions. This increase in length can allow the user assist 121 to counteract the motion of the foot pedal over a longer distance, which can reduce stress on the motion damper 120, can allow the user assist 121 to provide an increased compression force, and/or enable higher resolution of forces on the foot pedal 118. As a result, the user can open the large, heavy metal lid 122 with reduced force and the lid 122 will not easily open or close inadvertently. In several implementations, the motivating force provided by the user assist 121 is greater than the resisting force provided by the damper 120. For example, the ratio of the motivating force provided by the user assist 121 to the resisting force provided by the damper 120 can be at least about: 1.2, 1.5, 2.0, 2.5, 3.0, 4.0, 5.0, or otherwise.

In an example with a steel lid and without a user assist 121, a step force (the force required to be input by a user to open the lid) was about 105 N. In an example with a steel lid and with a user assist 121 having a spring rate of about 22 lbs./inch., the step force was about 75 N.

In an example with a plastic lid and without a user assist 121, the step force was about 74 N. In an example with a plastic lid and a user assist 121 having a spring rate of about 16 lbs./inch, the step force was about 71 N.

### 5. Certain Terminology

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### 6. Summary

Although the receptacle assemblies have been disclosed in the context of certain embodiments and examples, the receptacle assemblies extend beyond the specifically disclosed embodiments to other alternative embodiments and/or uses of the embodiments and certain modifications and equivalents thereof. For example, although certain embodiments with a foot pedal are described above, some embodiments include a handle, lever, button, motor, or other actuator (and/or associated sensors (such as proximity sensors, to actuate the actuator), a power source (such as a battery), and electronic controls) that is configured to be actuated by a user to open and close the lid. Any two or more of the components of the receptacle assembly can be made from a single monolithic piece or from separate pieces connected together. Various features and aspects of the disclosed embodiments can be combined with or substituted for one another in order to form varying modes of the invention. The scope of this disclosure should not be limited by the particular disclosed embodiments described herein. Additionally, any subject matter altered between the aforementioned priority document and the present disclosure shall not be construed as any lexicography, disclaimer, or disavowal unless expressly stated otherwise herein.

Certain features that are described in this disclosure in the context of separate implementations can also be implemented in combination in a single implementation. Conversely, various features that are described in the context of a single implementation can also be implemented in multiple implementations separately or in any suitable subcombination. Although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying drawings. The figures are drawn to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

In summary, various embodiments and examples of receptacle assemblies have been disclosed. Although the receptacle assemblies have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described above, but should be determined only by a fair reading of the claims that follow.

The following is claimed:

1. A receptacle comprising:
a first container configured to receive a first type of material,
a second container configured to receive a second type of material,
a movable lid configured to selectively cover and uncover the first container and the second container at the same time, the lid having a weight;
a base supporting the first container and the second container;
a foot pedal;
a linkage configured to transmit force between the foot pedal and the lid;
a damper configured to slow a transition of the lid from an uncovered position to a covered position, the damper configured to provide a resistance force to the foot pedal;
a user assist positioned between a top wall of the base and an upper surface of the foot pedal, the user assist configured to apply a motivating force to the foot pedal,
wherein the weight of the lid, the resistance force of the damper, and the motivating force of the user assist are selected to permit the lid to transition from the covered to the uncovered position upon the application of a force by a user to the foot pedal that is between about 70 N and about 80 N.

2. The receptacle of claim 1, wherein the user assist is positioned adjacent a front wall of the receptacle.

3. The receptacle of claim 1, wherein an exterior of the lid is metal.

4. The receptacle of claim 1, wherein the user assist is not connected with a rear wall and not positioned on an exterior surface of the receptacle.

5. The receptacle of claim 1, wherein the damper is positioned adjacent a rear wall of the receptacle.

6. The receptacle of claim 1, configured such that, during movement of the lid to the covered position, the user assist is compressed by the foot pedal.

7. The receptacle of claim 1, configured such that, during movement of the lid to the covered position, the user assist is stretched.

8. The receptacle of claim 1, wherein the user assist is positioned in a recess in the foot pedal.

9. A receptacle comprising:
a container,
a movable lid configured to selectively cover and uncover the container;
a base supporting the container;
a foot pedal;
a linkage configured to transmit force between the foot pedal and the lid;
a damper configured to slow a transition of the lid from an uncovered position to a covered position, wherein the damper applies a resistive force to the foot pedal or linkage rod in response to movement of the lid from the covered position to the uncovered position;
a user assist positioned between a top wall of the base and an upper surface of the foot pedal, the user assist configured to apply a motivating force to the foot pedal;
wherein a weight of the lid, a resistive force of the damper, and the motivating force of the user assist are selected such that the lid transitions from the covered position to the uncovered position upon the application of a force by a user that is approximately 75 N.

10. The receptacle of claim 9, wherein the user assist is positioned adjacent a front wall of the receptacle.

11. The receptacle of claim 9, wherein the lid is comprised of metal.

12. The receptacle of claim 9, wherein the lid is comprised of plastic.

13. The receptacle of claim 9, wherein the user assist is configured to provide a force that aids in opening the lid.

14. The receptacle of claim 9, wherein the damper is configured to dampen movement of the lid during movement from the uncovered position to the covered position.

15. The receptacle of claim 9, wherein the damper is configured to provide more resistance when the lid is moving from the uncovered position to the covered position than when the lid is moving from the covered position to the uncovered position.

16. The receptacle of claim 9, wherein the damper is positioned adjacent a rear wall of the receptacle.

17. A method of manufacturing a receptacle assembly, the method comprising:
attaching a body unit with a lid unit and a base portion to form a closed chamber;
pivotally connecting a foot pedal with the base portion;
operably connecting a linkage rod with the foot pedal and the lid unit such that the lid is configured to move in response to movement of the foot pedal;
positioning a damper near a rear wall of the receptacle; and
compressing a user assist between the foot pedal and the base portion.

18. The method of claim 17, further comprising positioning the user assist near a front wall of the body unit.

19. The method of claim 17, further comprising receiving a first end of the user assist in a recess in the base portion.

20. The method of claim 17, further comprising positioning the linkage rod on a rear of the body.
